(19) United States
(12) Patent Application Publication
(10) Pub. No.: US 2002/0066497 A1
(43) Pub. Date: Jun. 6, 2002

(54) Woodworking Equipment

(76) Inventor: Edwin Bernard Froggatt, Devon (GB)

Correspondence Address: Melvin I. Stoltz, Esq., 51 Cherry Street, Milford, CT, 06460, US

(21) Appl. No.: 10/013,903

(22) Filed: Dec. 11, 2001

(30) Foreign Application Priority Data
Mar. 16, 1999 (GB) 9905878.6
Jul. 23, 1999 (GB) 9917241.3
Mar. 16, 2000 (GB) 0006224.0

(51) Int. Cl. B27C 5/00

(52) U.S. Cl. 144/144.51

(57) ABSTRACT

Woodworking equipment for use in making a range of joints, including dovetail joints, includes a template (1.1) having an opening the sides of which define a track for the routing cutter of a router. The sides of the opening in the template (1.1) are defined by angle plates (1.6 and 1.7) which are reversible such that, in one condition of the angle plates (1.6 and 1.7), the opening in the template (1.1) is of dovetail form in plan while, in the reverse condition of the templates (1.6 and 1.7), the opening in the tempate (1.1) is parallel-sided.

### FIELD OF THE INVENTION

This invention relates to woodworking equipment and is concerned with such equipment which can be used in conjunction with a router to produce a number of different joint components including, in particular, dovetail joint components.

One form of such equipment is described in British Patent Specification No. 2 238 752 and includes a base having a datum face against which a component to be machined can be clamped, a template having an aperture through which a routing cutter can be passed for engagement with a clamped component, means for supporting the template in a position fixed relative to the datum face, the boundary of the aperture in the template defining a track along which the routing cutter is passed to effect the required machining operation, and means for adjusting the spacing between a pair of opposed sides of the aperture in the template.

It is an object of the present invention to provide improved woodworking equipment. More specifically, it is an object of the present invention to provide woodworking equipment which has a number of advantages as compared to the equipment described in British Patent Specification No. 2 238 752.

### SUMMARY OF THE INVENTION

According to a first aspect of the present invention there is provided woodworking equipment for use in the formation of a range of joints, said equipment including a template having an opening the sides of which define a track for the guidance of a routing cutter of a router, the sides of the template opening being defined by angle plates which are reversible such that, in one condition of the angle plates, the template opening is of dovetail form in plan and, in the reverse condition of the templates, the template opening is parallel-sided.

The template preferably includes a main body formed as a metal pressing and having an upstand, with a pair of slideways attached to the underside of the upstand to receive the edges of the angle plates.

Mounting means is preferably provided for mounting the equipment on a support structure such as a wall or bench.

A measurement assembly may be provided for measuring lengthwise movement of the template, the measurement assembly comprising a rule, a fixed pointer and a movable pointer.

An additional template which can be clamped to the workpiece may also be provided.

According to a second aspect of the present invention there is provided woodworking equipment which can be used in conjunction with a router to produce a range of different joint components, including dovetail joint components, said equipment including a pair of frame members between which a workpiece can be clamped while a routing operation is carried out thereon, an adjustable template for guiding movement of the router and mounting means for mounting the equipment on a support structure such as a wall or bench.

### BRIEF DESCRIPTION OF THE DRAWINGS

FIG. 1 is a first plan view showing the template set for cutting stopped or through dovetails and illustrating the template movement measuring facility,

FIG. 2 is a side view of the arrangement shown in FIG. 1,

FIG. 3 is an end view showing a clamped workpiece,

FIG. 4 is a second plan view of the template set to the parallel slot facility for cutting tails or finger/comb joints,

FIG. 5 is a plan view showing use of a dovetailer template having a wider bottom flange than that shown in FIG. 4,

FIG. 6 is an end view of the arrangement shown in FIG. 5,

FIG. 7 is a plan view of one type of template assembly,

FIG. 8 shows the individual components of the template assembly of FIG. 7,

FIG. 9 shows a template transverse movement locking piece,

FIGS. 10, 11 and 12 show angled plates,

FIG. 13 shows an assembly plus parts of the assembly,

FIG. 14 shows further parts of the assembly shown in FIG. 13,

FIG. 15 shows a measurement assembly plus parts of the measurement assembly,

FIG. 16 shows the use of cutter protecting strips and an adjustable stop and side guide,

FIG. 17 shows adjustable angle plates,

FIG. 18 shows the formation of stopped dovetails and the use of a setting block in the formation of the stopped dovetails,

FIG. 19 shows the formation of through dovetails and the steps involved in the formation of the through dovetails,

FIG. 20 shows the formation of a finger, comb or box joint,

FIG. 21 shows a wall mounting arrangement for use when working on long workpieces,

FIG. 22 shows a jointer template,

FIG. 23 shows the components of the jointer template,

FIG. 24 is a plan view of a template assembly which includes an adjustable workpiece platform, said template assembly including the template of FIG. 5,

FIG. 25 is a sectional view of the arrangement shown in FIG. 24,

FIG. 26 shows the components of the assembly shown in FIG. 24,

FIG. 27 shows the use of a range of different routing cutters for the formation of a number of different joint configurations,

FIG. 28 shows a measurement assembly plus the individual parts thereof, and

FIG. 29 shows another wall mounting arrangement for the equipment.

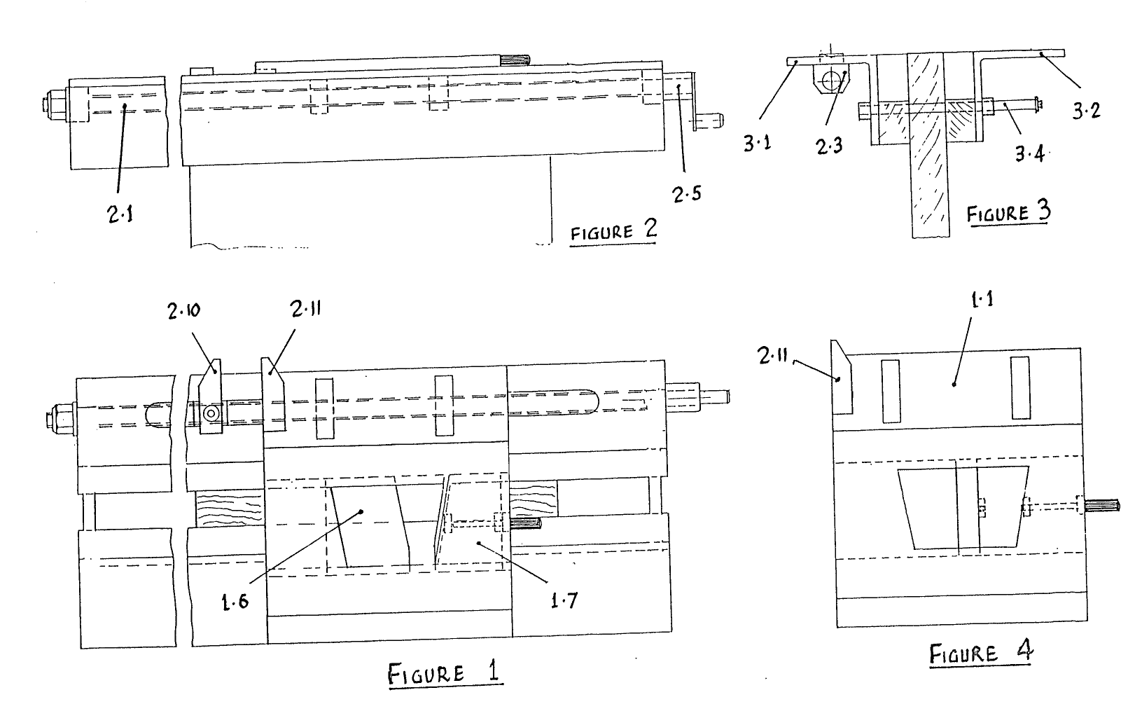

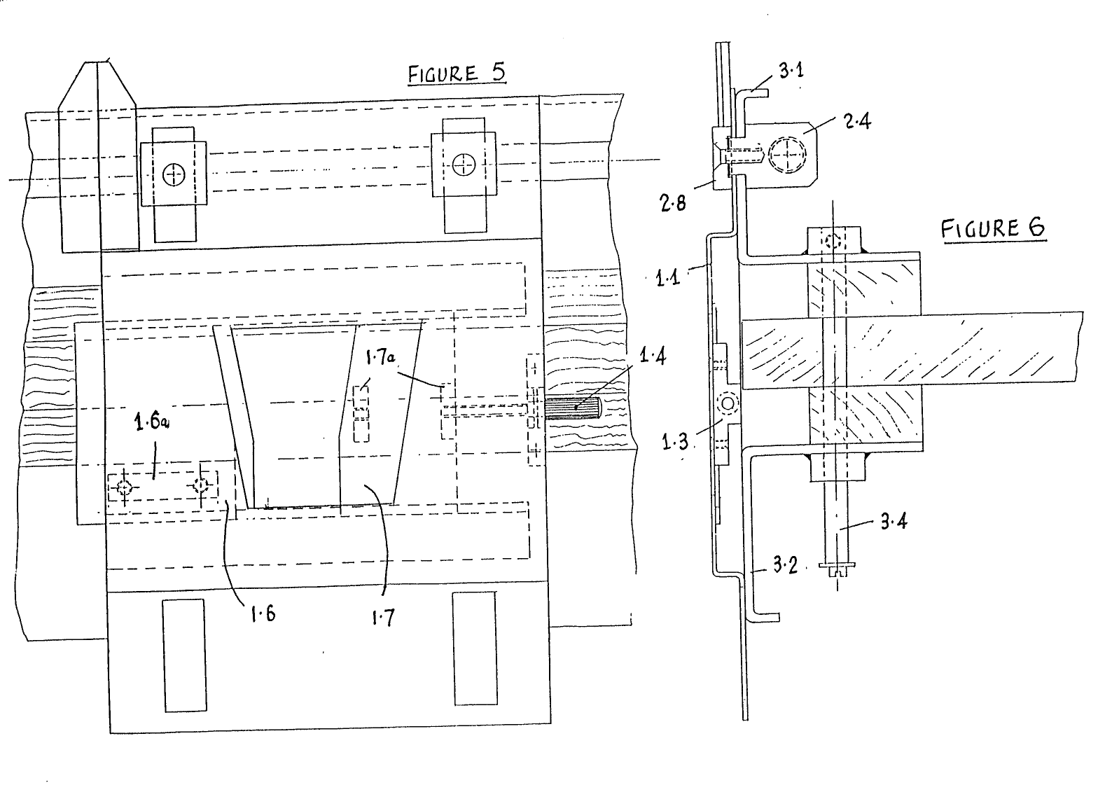

### DESCRIPTION OF THE PREFERRED EMBODIMENTS

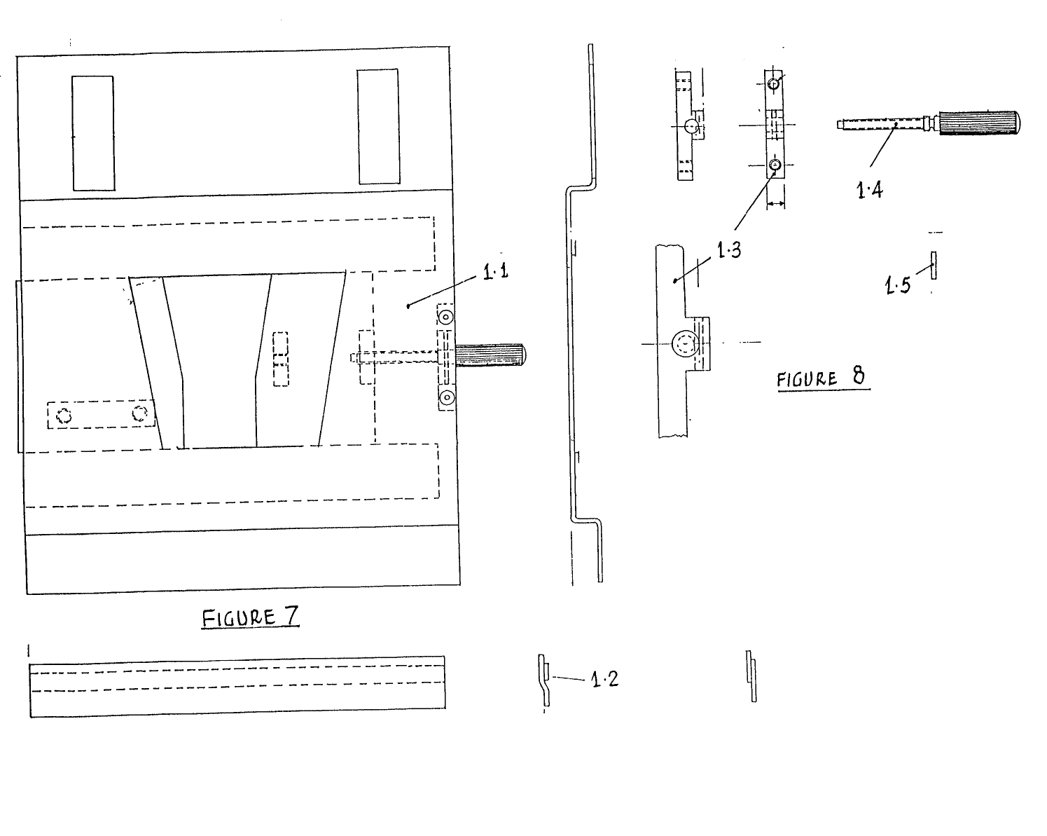

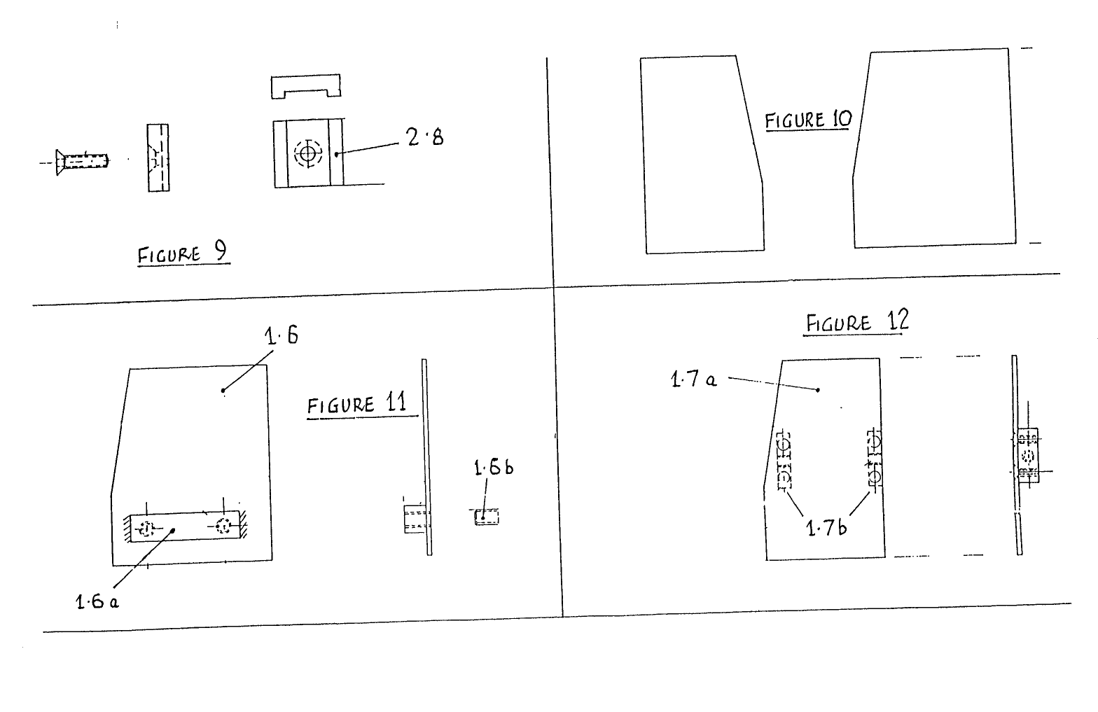

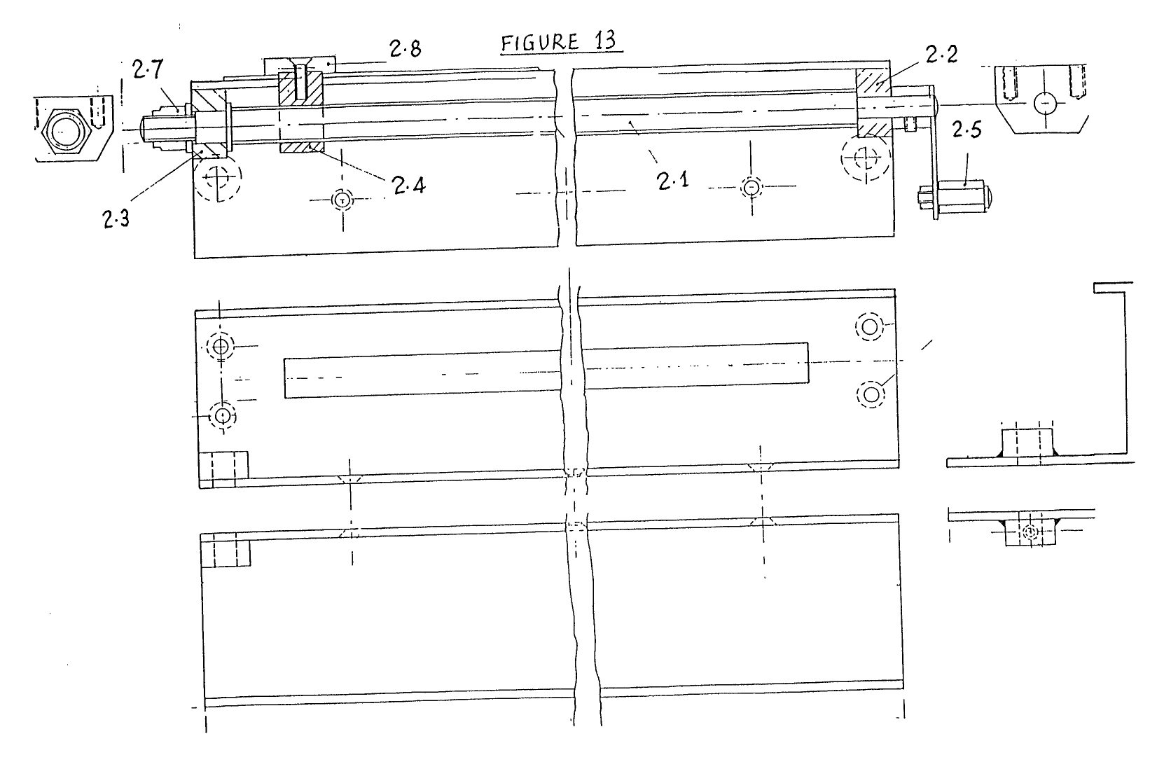

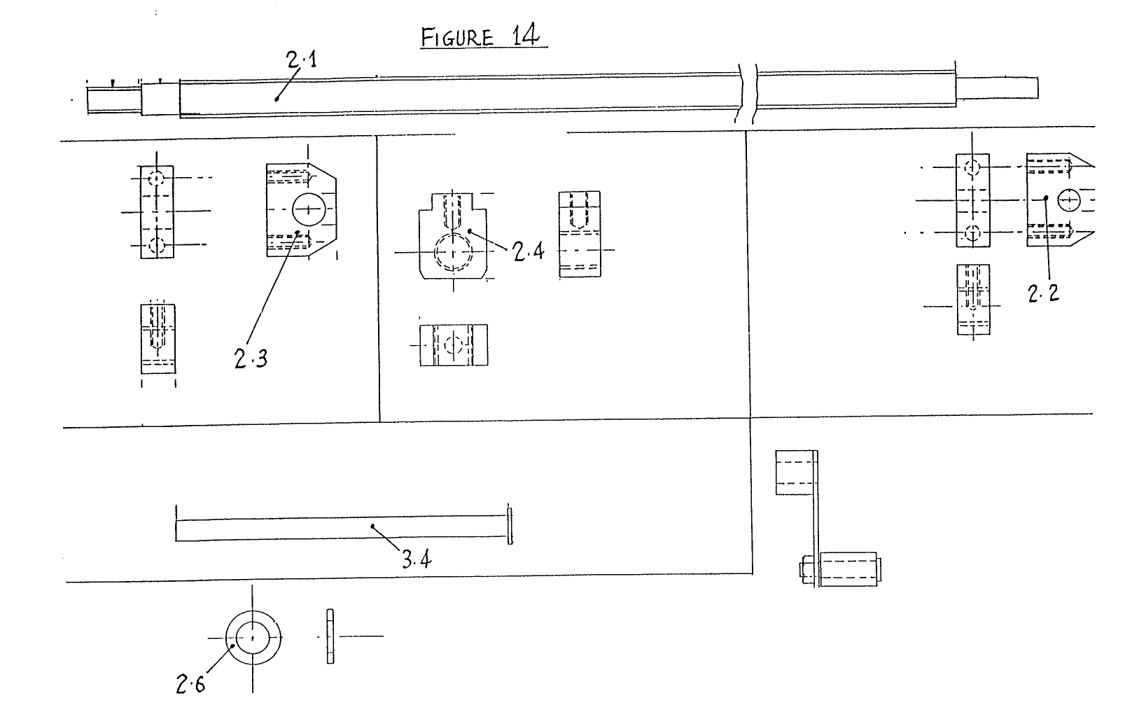

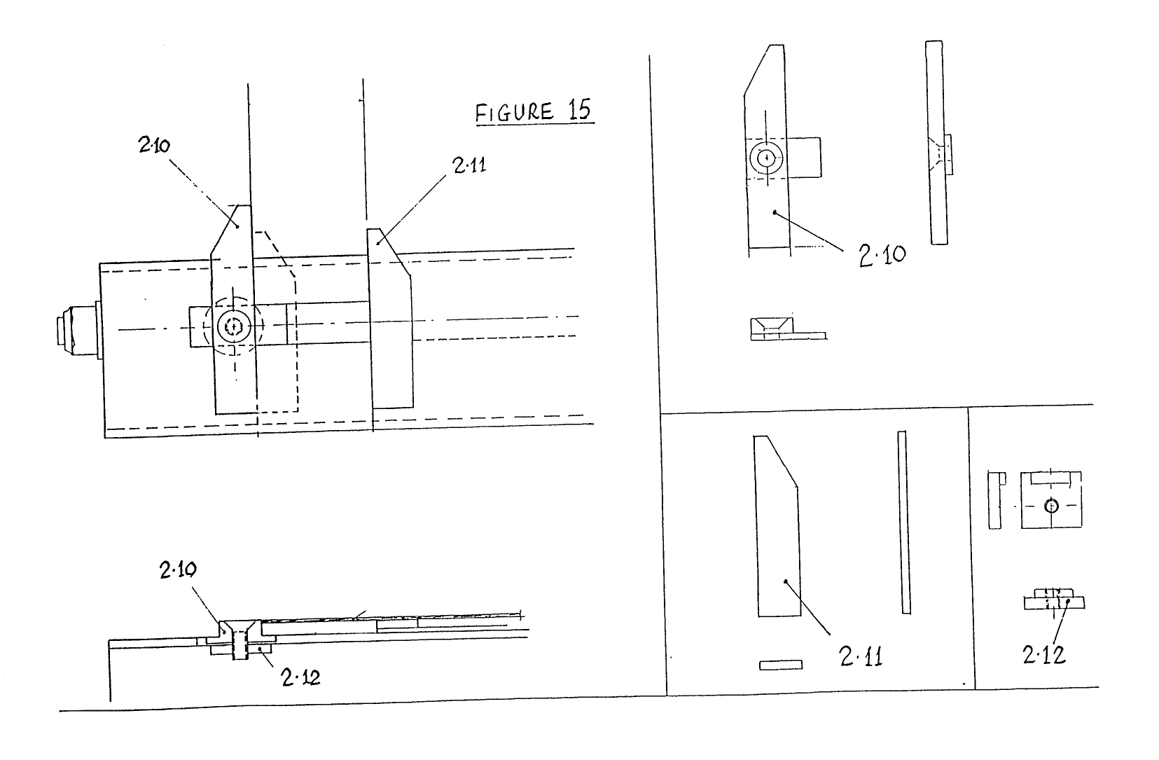

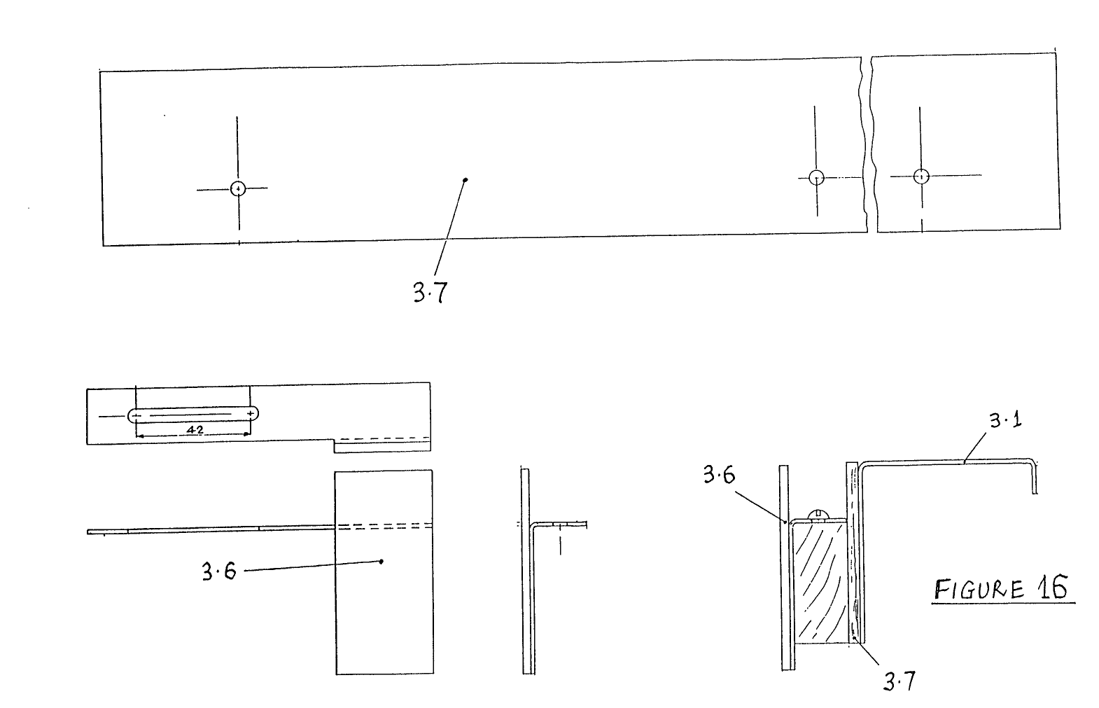

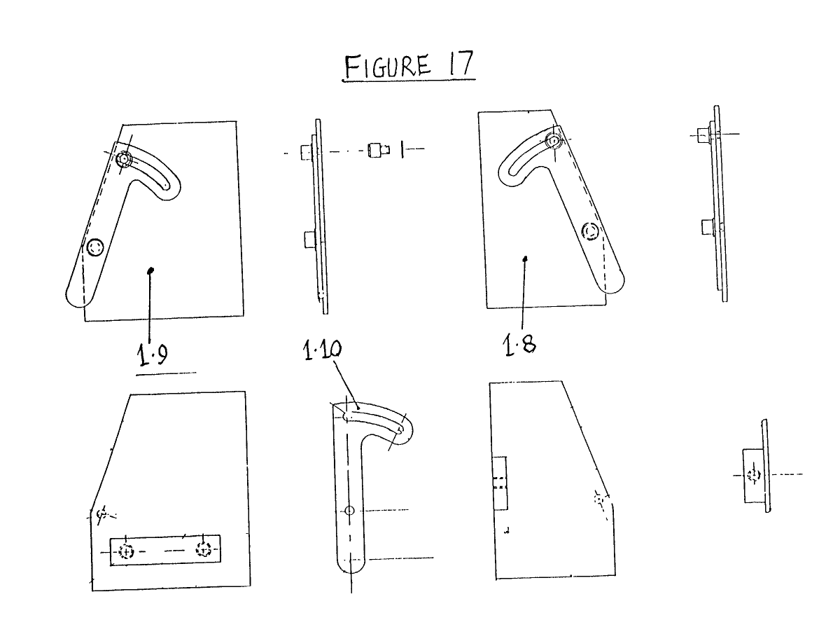

The template body 1.1 (see particularly FIG. 7) is a 1.5 mm. thick sheet steel pressing of top-hat form in section and, in a particular embodiment, its dimensions are 160 mm. long and 200 mm. wide. The body 1.1 has an upstand which has dimensions of 160 mm. by 125 mm. and stands proud of the remainder of the body by 12 mm. A dovetail-shaped central opening is blanked out of the upstand.

On the underside of the upstand are a matching pair of slideways 1.2 and, as can be seen from FIG. 7, the upstand has two flanges, the wider of which has two 15 mm. by 40 mm. slots blanked out of it.

Also, secured to the right-hand edge of the underside of the template body 1.1 is a screw block 1.3 with an M4 actuating screw 1.4. The screw 1.4 rotates freely in the screw block 1.3 and is retained by means of a short retaining pin 1.5 which engages in a groove in the screw 1.4.

Two rectangular angle plates 1.6 and 1.7 are made from steel plate 1.5 mm. thick and are zinc plated after manufacture. One side of each angle plate is cut at an angle of 100° to the top face, this being the commonest dovetail angle. The right hand angle plate 1.7 has two M4 screw blocks 1.7b fastened to its underside, one to provide fine adjustment to one side of the dovetail opening and the other to provide fine adjustment when the plate 1.7 is reversed when it is desired to form a parallel slot. The left hand angle plate 1.6 has a strip of steel fastened lengthways to its underside and has a locking screw in two positions to secure the plate when it has been positioned manually.

The template is of vital importance in controlling a plunging router during the cutting of the pins and tails of both stopped and through dovetails. It does this by means of the right hand and left hand angle plates 1.7 and 1.6 which, together, give the template body its variable dovetail, configuration. The template guide fastened to the bottom of the router bears against the sides of this dovetail-shaped opening and causes the router to follow accurately the defined shape.

The left hand angle plate 1.6 is moved manually and can be locked in position by a hollow socket screw. The right hand angle plate is moved by the M4 screw 1.4 to provide fine adjustment of the dovetail shape.

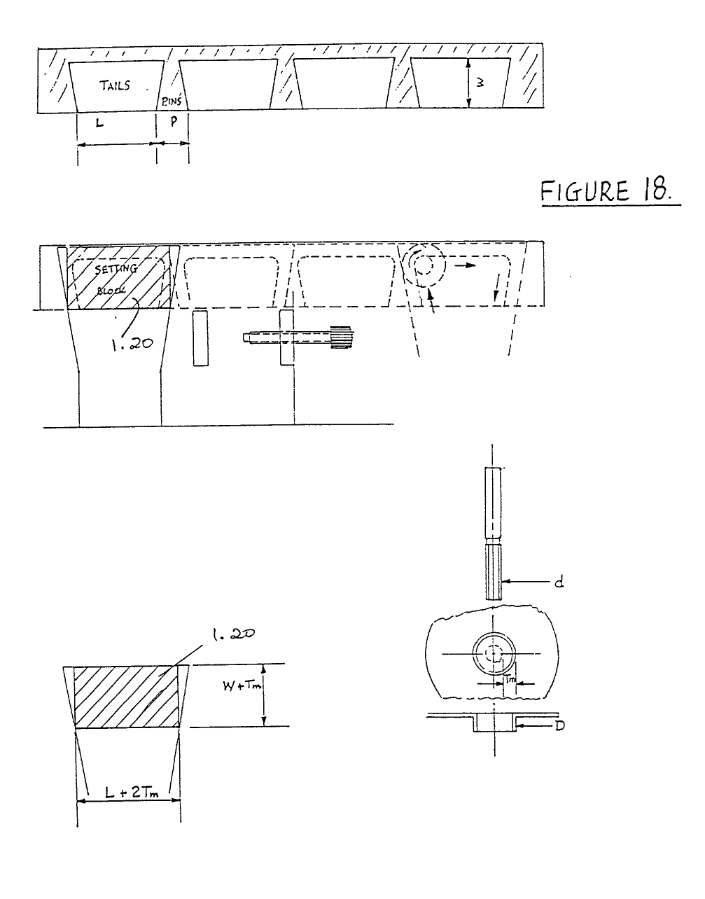

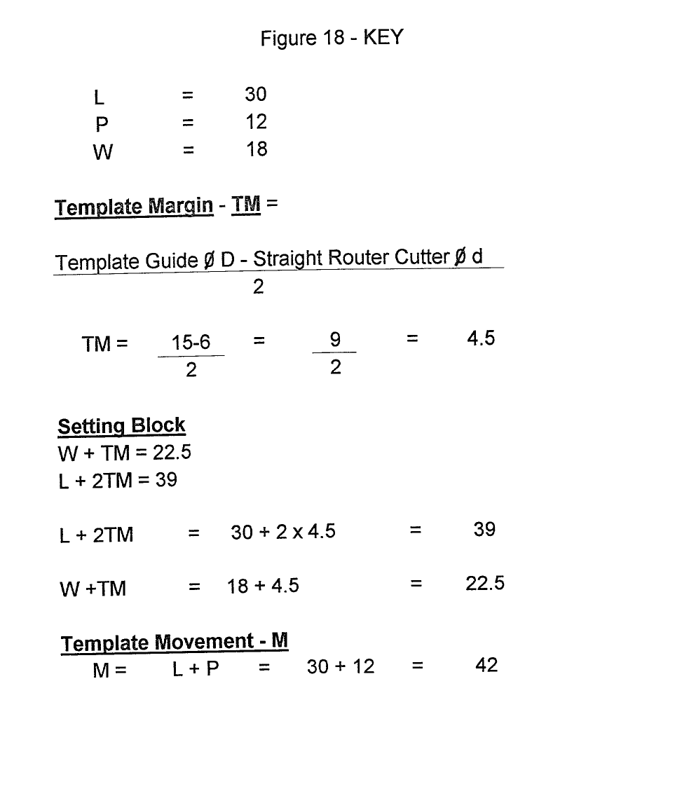

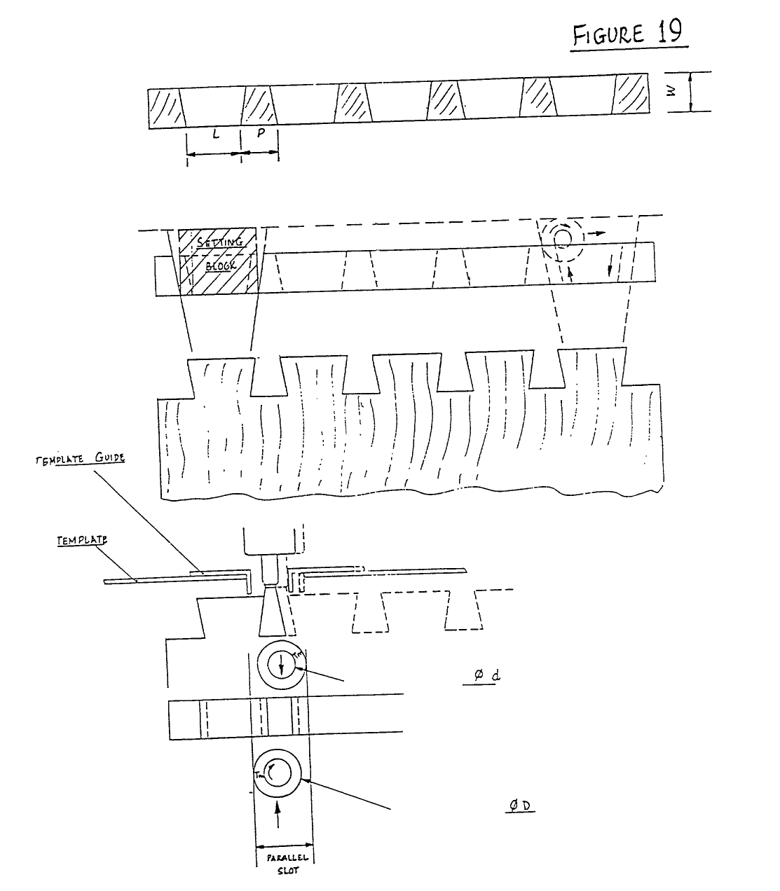

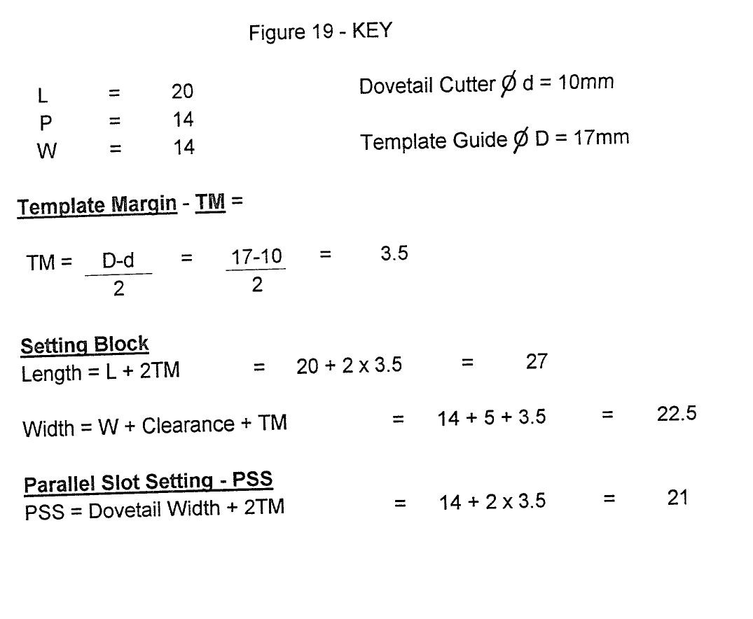

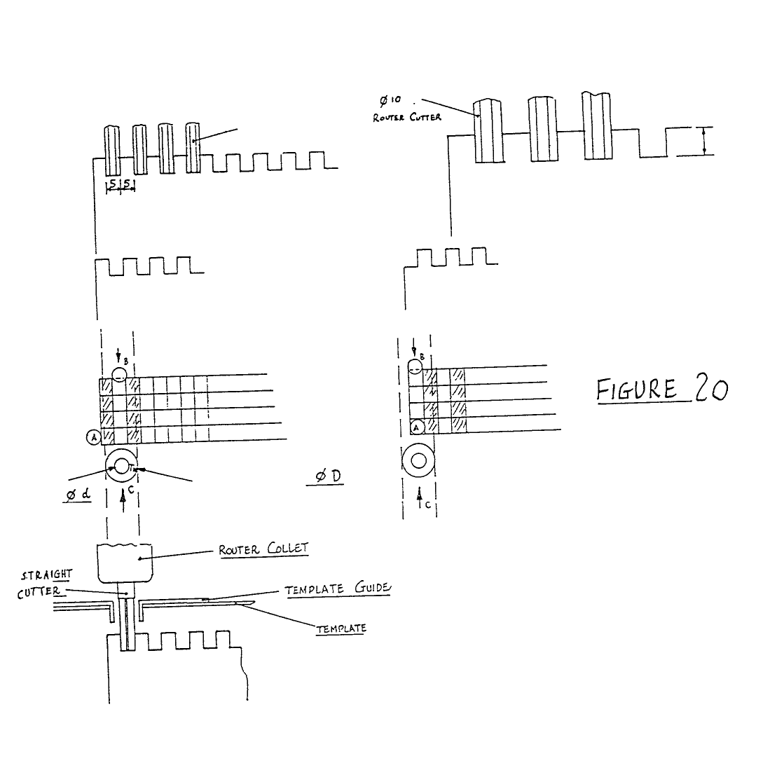

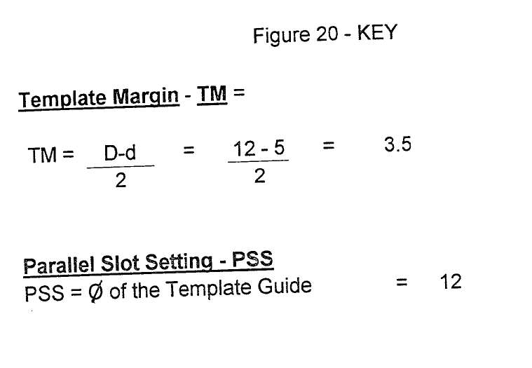

When the length and width of the dovetail has been decided, a re-usable setting block 1.20 is made in either hardwood or aluminium. The setting block 1.20 is held lightly in the dovetail opening, as shown in FIG. 18. Then the template is moved crossways, with square projections on two positional screw carriers 2.4 engaging in the slots in the template flange, until the lower edge of the setting block 1.20 is in line with the lower edge of the workpiece. The template is then locked down on the carriers 2.4 by a locking piece 2.8.

Movement of the template is effected using a main screw 2.1 (M14×2 mm. pitch) which is supported by bearing blocks positioned at either end of a sheet metal angle 3.1. One end of the main screw 2.1 has a handle 2.5 for turning the screw 2.1. The two positional carriers 2.4 for the template are mounted on the screw 2.1, the upper end of the template being reduced to a 15 mm. square shape which runs in a slot in the angle 3.1 and which also provides the means of transverse movement of the template. Clamping pieces 2.8 are provided so that the squareness of the template is maintained at all times by locking it to the carriers 2.4.

The template can be adjusted to cut any length of dovetail between 8 mm. and 55 mm. Moving the template from one cutting station to the next by means of the main screw 2.1 determines the spacing of the dovetails.

Measurement of the movement of the template is made by means of a rule between two pointers 2.10 and 2.11. The pointer 2.11 attached to the left-hand edge of the template is fixed, while the other pointer 2.10 is movable and can be moved along the slot in the angle into contact with the fixed pointer at the beginning of the cutting sequence and then locked in position on the angle.

A straight router cutter is used for cutting the pins of both types of dovetail, but the cutter is changed to a dovetail shape for cutting the tails. At the same time, the angle plates 1.6 and 1.7 are reversed to form a parallel slot, the width of which controls the finished width of the tails, which can measure from 5 to 50 mm. in length.

Additional special angle pieces can be used to produce different dovetail angles. They have lockable, pivoting quadrant pieces operating on the angled side of the plates 1.6 and 1.7.

Clamping of the template is effected using the two equal right-angle pieces 3.1 and 3.2. Each piece 3.1 and 3.2 has a stiffening down-turned flange and 40×20 mm. softwood strips are attached to the vertical legs of the angle pieces 3.1 and 3.2. The left-hand angle piece 3.1 has a 15 mm. slot cut along part of the length of its horizontal leg and strips of 4 mm. thick plywood can be sandwiched in between each angle piece 3.1 and the softwood strips.

Steel bushes are welded to the vertical legs of both angle pieces 3.1 and 3.2 at either end to take alignment rods 3.4. One set of bushes on the left-hand angle piece 3.1 have locking screws and the alignment rods 3.4 have an end stop.

The right-angle pieces 3.1 and 3.2 are used to clamp the workpiece using a G-clamp or similar quick clamping method. The faces to be cut must be level with the top faces of the angle-pieces 1 and 2 and a straight edge is, therefore, employed to check the accuracy of the clamping procedure.

The measurement assembly shown in FIG. 28 includes a movable pointer 2.10 which is lengthened as compared to the movable pointer 2.10 shown in FIG. 1 so that an additional cross-piece can be added, either by screws or by spot-welding. The additional cross-piece acts as a carrier for the steel rule 2.20 and is spot-welded to it. A central support piece for the steel rule is spot-welded to the main angle 3.1 and the fixed pointer 2.11 has a bevel machined on one side of it.

When setting up to begin cutting a joint, it is necessary and important, as conditions change, such as router cutter diameter, to zero the movable pointer 2.10. Every joint that is cut has a datum point, but not necessarily the same every time. The equipment accordingly includes a movable datum point which is easily set at the beginning of the cutting of every joint or batch of joints. It makes the measurement of template movement very much easier. It also enables the user to square up the template after the necessary transverse adjustment has been made when cutting a different size of joint.

In use, having chosen the dimensions of the joint, the user selects the appropriate setting block, guide bush and router cutter. He then raises or lowers the workpiece platform until it is exactly the thickness of the workpiece below the top surface of the left-hand main clamping angle 3.1. The screws and nuts at either end are now tightened and one or more lengths of wood laid horizontally on the slotted baseboard and moved until the ends to be cut are in line with the end of the baseboard. The user then locks the one or more lengths of wood in position with the clamping fixtures.

The setting block is lightly pinched in the template which is adjusted transversely until the top edge of the setting block is in line with the top edge of the workpiece(s). The template is then locked down on the template carriers and the routing operation carried out.

FIG. 17 shows angle plates 1.8 and 1.9 (which include quadrant pieces 1.10) which are adjustable, to provide angles from 90° to 110°, for use with the dovetail templates.

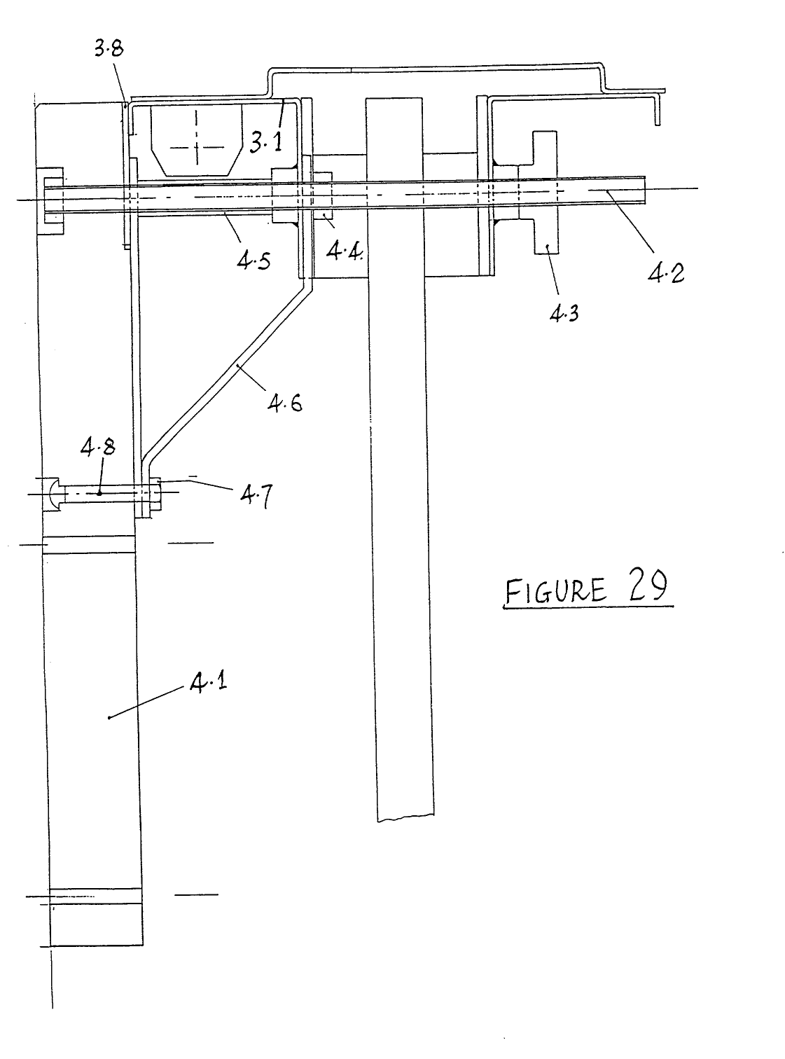

FIG. 29 shows a means for mounting the equipment on a wall or on the front of a bench, either permanently or removably, whilst obviating the need for separate clamping by G-clamps in most applications. It may, however, be necessary in the case of heavy workpieces, to apply additional clamping power to the two main angles on the workpiece by G-clamps.

There are two wall supports 4.1, in the form of lengths of hardwood, preferably beech, 35×40×300 mm. long—each drilled and counterbored for an M.10 screwed rod and nut 4.2 and 4.3, and for an M.6 coach screw and nut. The lengths of hardwood 4.1 provide the primary support at either end of the main sheet metal angle 3.1 for mounting the equipment on the wall or bench front.

The screwed rods 4.2 are 220 mm. lengths of standard M.10 B.M.S. screwed rod and provide the means for:

a) forming a strong cantilever support for the main angle 3.1 by clamping it together with the wooden support and the steel bracket,

b) maintaining the alignment of the complementary main angle 3.2, and

c) enabling the workpiece to be clamped between the angles during the cutting sequence using hand nuts 4.3 to provide the clamping pressure.

The hand nuts 4.3 are B.M.S. hand nuts and are used with a heavier than usual workpiece to apply a preliminary pinching pressure on the workpiece. One or two G-clamps is or are then used to retain the workpiece securely during cutting.

Standard M.10 steel locking nuts 4.4 are tightened on to the screwed rods 4.2 and spacers 4.5 are inserted, during assembly, between each bracket 4.6 and the main angle 3.1, so ensuring that all the components can be clamped tightly together. The brackets 4.6 are lengths of 30×3 steel strip which are pierced and formed, and then spot-welded at the lower end to provide the required configuration. Nuts 4.7 are tightened on to bolts 4.8 to secure the lower ends of the brackets 4.6 to the wall supports 4.1.

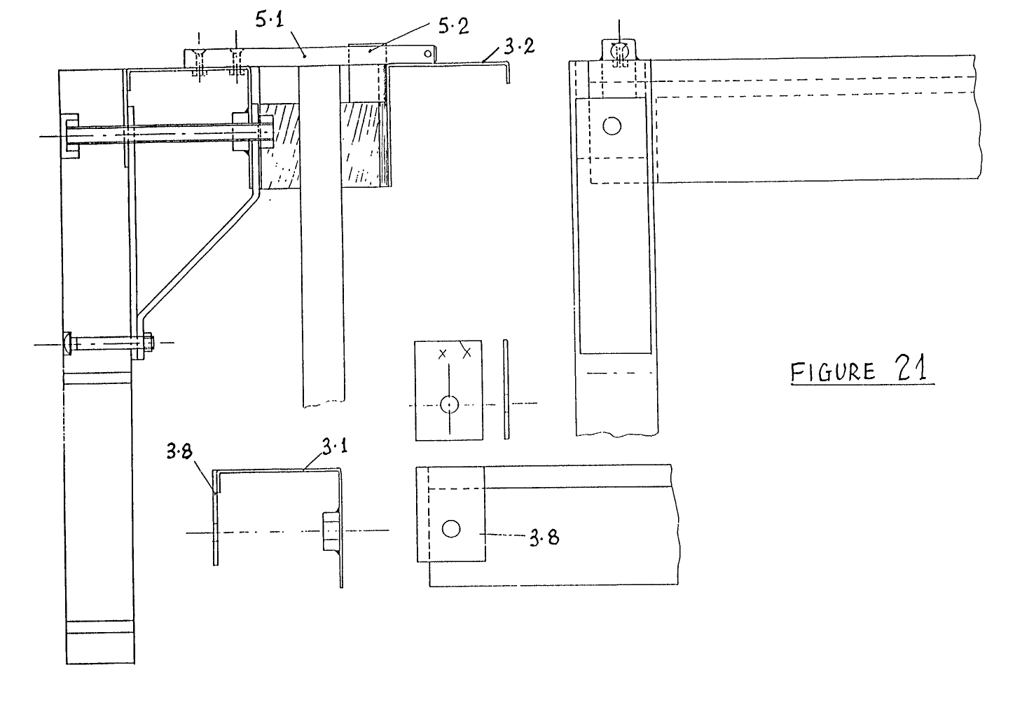

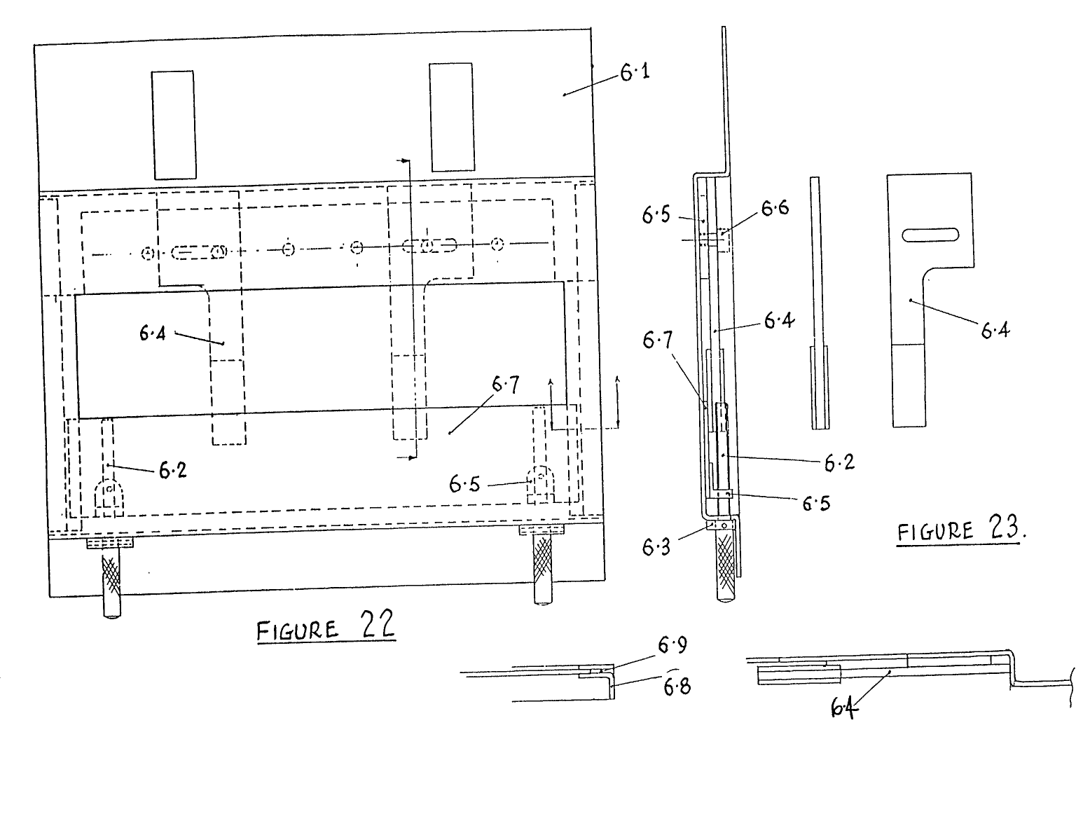

Another wall mounting assembly is shown in FIG. 21. The screwed rods 4.2 of the assembly shown in FIG. 29 have the effect of limiting the width of the workpiece that can be cut, i.e. the workpiece must be no wider than the distance between the screwed rods 4.2. Any width of workpiece can be processed using the wall mounting assembly of FIG. 21 since the alignment rods 5.1 for the main angle 3.1 are positioned above the level of the workpiece, but below the level of the top surface of the template. The means of alignment is, in this case, contained within the total 12 mm. thickness of the template.

The alignment rods 5.1 are steel rods which are drilled and countersunk at one end to receive an M.4 countersunk screww and nut. The alignment rods 5.1 are removably secured at either end of the main angle 3.1 so that the alignment of both angles is maintained, whatever the thickness of the workpiece. This is achieved by the alignment rods 5.1 passing through identical steel blocks 5.2 permanently fastened by screws or by welding to plates 3.8 welded to the main angles 3.1.

There are two B.M.S. blocks 5.2 and they are each 25×20×42 mm. long. One block 5.2 is fastened to each end of the main angle 3.2. The provision of the blocks 5.2 ensures that the main angle 3.2 is maintained accurately parallel to the main angle 3.1 whilst sliding freely to accommodate workpieces of varying thickness. Clamping of the workpieces is effected by means of G-clamps or other clamping mechanisms.

FIG. 21 shows an alternative means of support for the outer clamping angle 3.2. This permits joints to be cut in a workpiece of greater length than the body of the equipment. This is achieved by positioning the guide rod 5.1 above the workpiece and attaching it to the upper face of the main angle 3.1. There is one alignment block 5.2 at each end of the outer clamping angle 3.2.

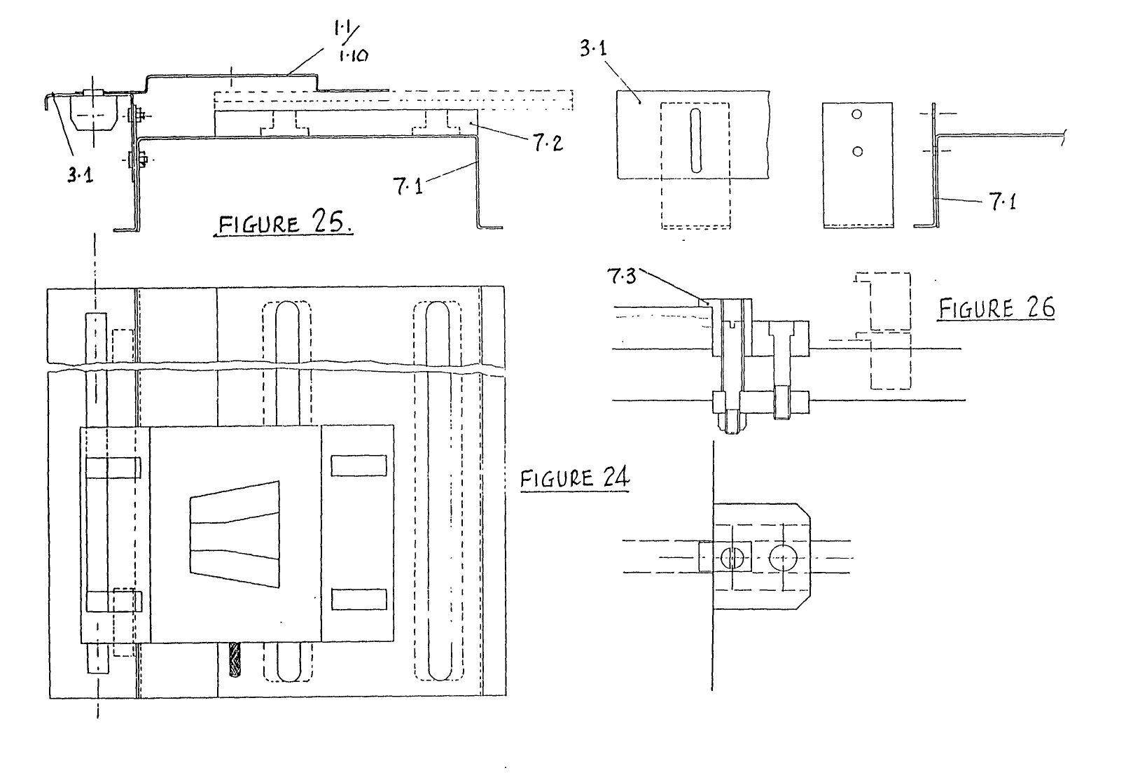

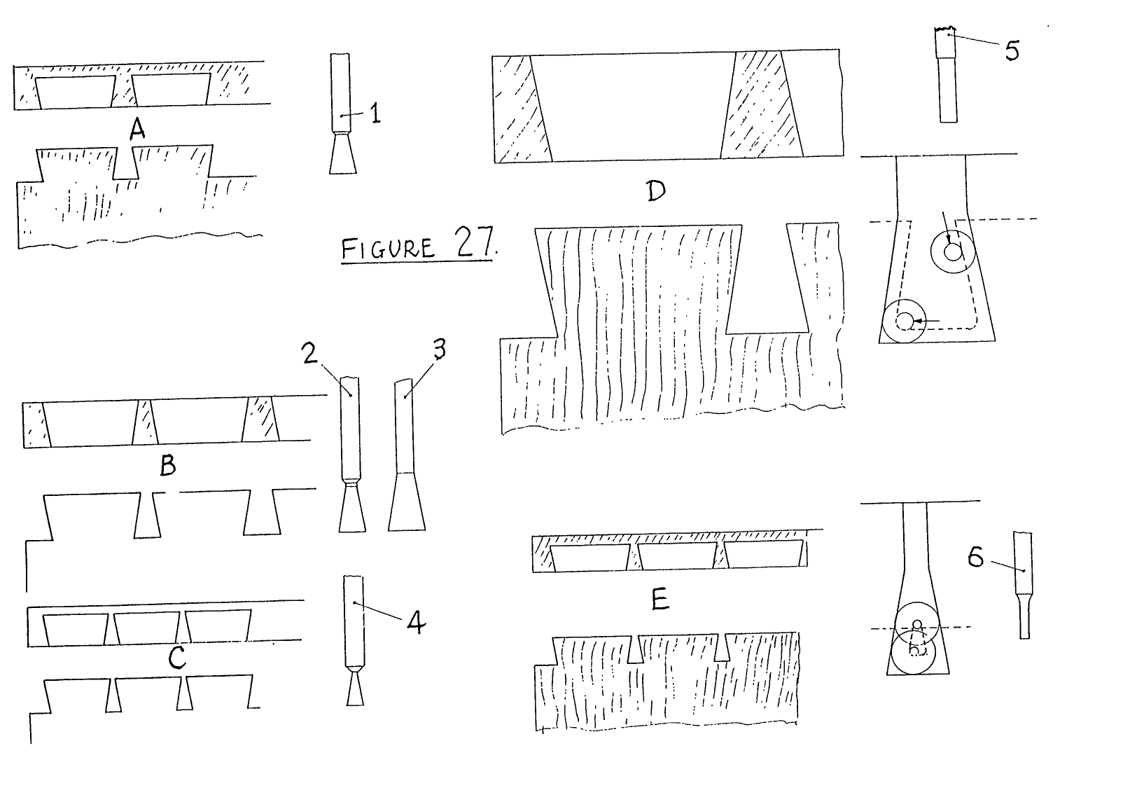

FIGS. 24 to 26 show another form of template assembly. This includes an adjustable workpiece platform 7.1 which is formed from sheet metal folded or pressed into an inverted channel section with a flange along the right-hand side. Set in from either end are five angle pieces which are spot-welded to the inverted channel section and drilled with holes for the clamping screws.

The platform 7.1 is adjustable vertically to allow for different thicknesses of workpiece to be held on the slotted baseboard 7.2. Even if several workpieces are clamped on the baseboard 7.2 using the clamping fixtures 7.3, the upper surface of the top piece must be adjusted so that it is level with the top surface of the left-hand main angle 3.1. This is because the workpiece supports the template whilst cutting is taking place.

The slotted baseboard 7.2 is formed from MDF and is cut eith two or more slots which are rebated at their lower ends. The slotted baseboard 7.2 supports the workpiece(s) and the rebated slots are provided to receive the clamping fixtures which hold the workpiece(s) whilst cutting is taking place.

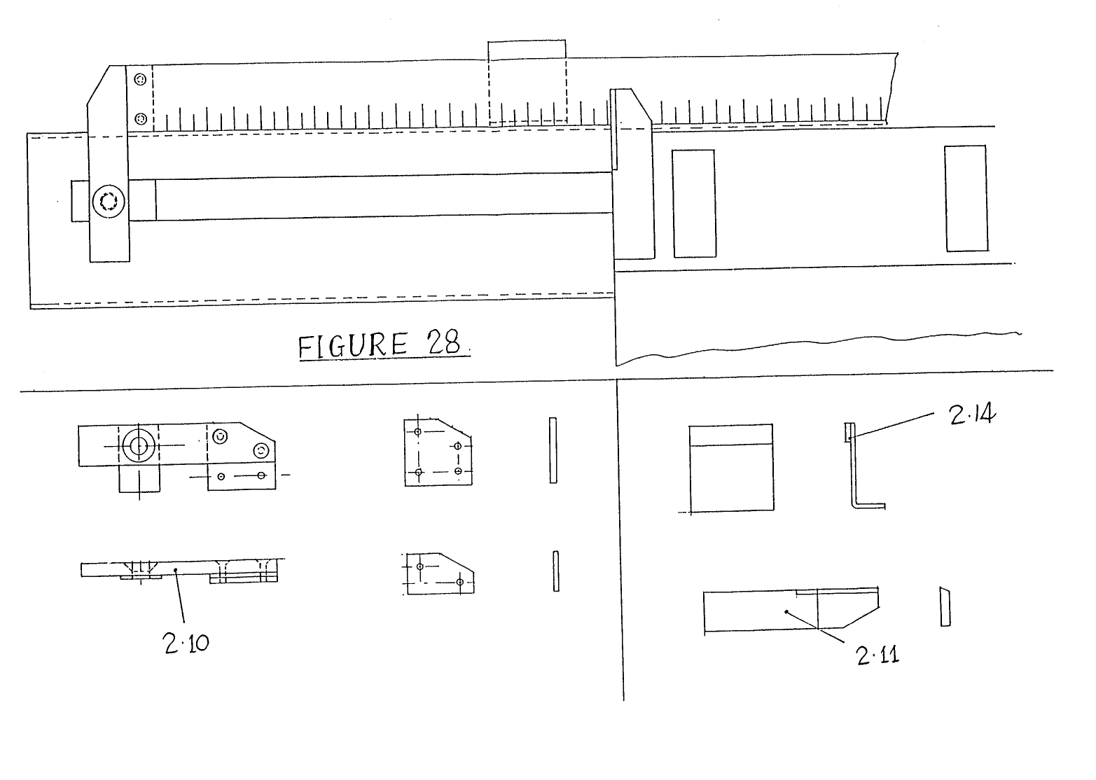

FIG. 27 shows the formation of a range of joints. The cutter 1 used to cut the pin socket of joint A is the optimum shape as regards strength. If one were to make the cutter more slender as shown at 2 for joint B, the cutter could break ff when making the cut which has to be achieved in one pass. The joint would have to be redesigned and a larger cutter 3 would have to be used. Joint C, for which one would have to use cutter 4, would not even be contemplated.

At the larger end of the range of the joints to be cut, as in joint D, a dovetail-shaped cutter would be expensive to produce for occasional use. Instead, a parallel-sided cutter 5 is used. Cutter 6 will be used to produce joint E.

Use of the equipment of the present invention thus enables the socket size for the pins to be infinitely variable in shape and size, thus leading to a saving in the cost of making large dovetail-shaped cutters.

It will be appreciated that the dimensions given on the drawings are giving purely by way of example and that many detail changes can be made to the equipment shown in the drawings.

1. Woodworking equipment for use in the formation of a range of joints, said equipment including a template having an opening the sides of which define a track for the guidance of a routing cutter of a router, the sides of the template opening being defined by angle plates which are reversible such that, in one condition of the angle plates, the template opening is of dovetail form in plan and, in the reverse condition of the templates, the template opening is parallel-sided.

2. Woodworking equipment as claimed in claim 1, in which the template includes a main body formed as a metal pressing and having an upstand.

3. Woodworking equipment as claimed in claim 2, which includes a pair of slideways attached to the underside of the upstand to receive the edges of the angle plates.

4. Woodworking equipment as claimed claim 1, which includes mounting means for mounting the equipment on a support structure.

5. Woodworking equipment as claimed in claim 1, which includes a measurement assembly for measuring lengthwise movement of the template.

6. Woodworking equipment as claimed in claim 5, in which the measurement assembly comprises a rule, a fixed pointer and a movable pointer.

7. Woodworking equipment as claimed in claim 1, which includes an additional template which can be clamped to the workpiece.

8. Woodworking equipment which can be used in conjunction with a router to produce a range of different joint components, including dovetail joint components, said equipment including a pair of frame members between which a workpiece can be clamped while a routing operation is carried out thereon, an adjustable template for guiding movement of the router and mounting means for mounting the equipment on a support structure.
